(19) United States
(12) Patent Application Publication
(10) Pub. No.: US 2007/0047837 A1
(43) Pub. Date: Mar. 1, 2007

(54) Method and apparatus for detecting non-people objects in revolving doors

(76) Inventors: John Schwab, Framingham, MA (US); Sanjay Nichani, Natick, MA (US)

Correspondence Address: ARTHUR J. O'DEA;LEGAL DEPARTMENT, COGNEX CORPORATION, ONE VISION DRIVE, NATICK, MA, 01760-2077, US

(21) Appl. No.: 11/215,307

(22) Filed: Aug. 29, 2005

(51) Int. Cl. G06K 9/36

(52) U.S. Cl. 382/285

(57) ABSTRACT

A stereo imaging based vision system and method provides enhanced portal security through stereoscopy. In particular, a system detects non-people objects within the chamber of a revolving door by acquiring two-dimensional (2D) images from different vantage points, and computing a filtered set of three-dimensional (3D) features of the door compartment by using both the acquired 2D images and model 2D images. Applying image processing techniques to the filtered 3D feature set, non-people objects can be detected.

### BACKGROUND

Automated and manual security portals provide controlled access to restricted areas, such as restricted areas at airports, or private areas, such as the inside of banks or stores. Examples of automated security portals include revolving doors, mantraps, sliding doors, and swinging doors.

In particular, FIG. 1A is a block diagram of an access controlled revolving door 10. The revolving door 10 includes a door controller 30 that is coupled to an access control system 20. The access control system 20 may operate on a motion control basis, alerting the door controller 30 that an individual has entered or is entering a compartment in the revolving door 10. An automated door may begin to rotate when an individual steps into a compartment of the revolving door. A manually driven revolving door may allow individuals to pass through the portal by physically driving the door to rotate. A manual revolving door may include an access control system 20 and door controller 30 that allows for the automated locking of the door. Alternatively, to pass through the revolving door 10, the access control system 20 may require a person to validate his authorization. The access control system 20 alerts the door controller 30 that valid authorization was received.

### SUMMARY OF THE INVENTION

The present invention provides a method and system that may detect foreign objects within a compartment of a revolving door, whether located on the floor within the revolving door or on the wall of the revolving door. These foreign objects might include such things as boxes, brief cases, or guns.

FIGS. 1B and 1C are a top view diagram illustrating a revolving door dragging a non-people object through a portal. As shown in FIGS. 1B and 1C, a revolving door 10 provides access between a secured area 50 from a public area 55. Wings 12, 14, 16, 18 may separate the door into compartments or chambers for a person to walk through. The number of wings and compartments may vary between different types of revolving doors. One concern at automated security portals is that someone will put a box 41 in a compartment of the revolving door 10 from an outside unsecured area. Someone interested in transporting the box into the secured area may slide the box into the revolving door 10 between two wings 12, 14 of an entry ingress side 215. A person 1 leaving the secured side 50 through an exit egress 225 will drive the revolving door 10 to rotate. As the door 10 revolves, the wing 14 drags the box 41 toward the secured area 50 of a building unbeknownst to any security people. Alternatively, embodiments of the present invention may be applied to detect non-people objects being removed from a secured area.

Another concern at security portals is that someone might attach a gun, or other device to a wing of a revolving door. FIGS. 1D and 1E illustrate a gun 42 attached to a wing 14 of the revolving door 10. The gun is smuggled into a secured area 50 as person 1 leaves through the exit egress 225 of the revolving door 10, causing the door 10 to rotate. When the door 10 rotates, the wing 14 moves toward the secured area 50 with the gun 42 remaining attached to the door 10.

Although security personnel may monitor the portals for any such non-people objects, human error or limited visibility may prevent security personnel from detecting non-people objects passing though the portal, particularly when the objects are small in size.

Generally, revolving doors are made of glass, or other transparent material, to allow visibility as individuals travel through the door. However, a two-dimensional (2D) view of a glass door can pose some difficulty in distinguishing whether an object is located within a compartment inside the glass of the door, as opposed to outside the glass of the door.

Embodiments of the present invention are directed at portal security systems and methods of providing enhanced portal security through stereoscopy. The present invention provides a method of detecting non-people objects within the chamber of the revolving door by acquiring 2D images, interchangeably referred to herein as “image sets,” from different vantage points, and computing a filtered set of three-dimensional (3D) features of the door compartment by using both the acquired 2D images and model 2D images. In a preferred embodiment, a processor can run during cycles when no objects are detected, to create the model 2D images. Alternatively, static 2D model images can be used as well. Applying various image processing techniques to the filtered 3D feature set, non-people objects can be identified. In embodiments of the present invention, an identified non-people object can be tracked to confirm that the identified object is more than a transient image.

Embodiments of a portal security system of the present invention can include (i) a 3D imaging system that generates from 2D images a target volume about a chamber in a revolving door and (ii) a processor that detects non-people objects within the target volume to detect a potential security breach.

Once a non-people object is detected, embodiments of the system can transmit a notification alarm. The alarm may be received by an automated system to stop the revolving door, or take other appropriate action. The alarm may also be used to alert human personnel to a potential security breach.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is a block diagram of an access controlled revolving door according to the prior art;

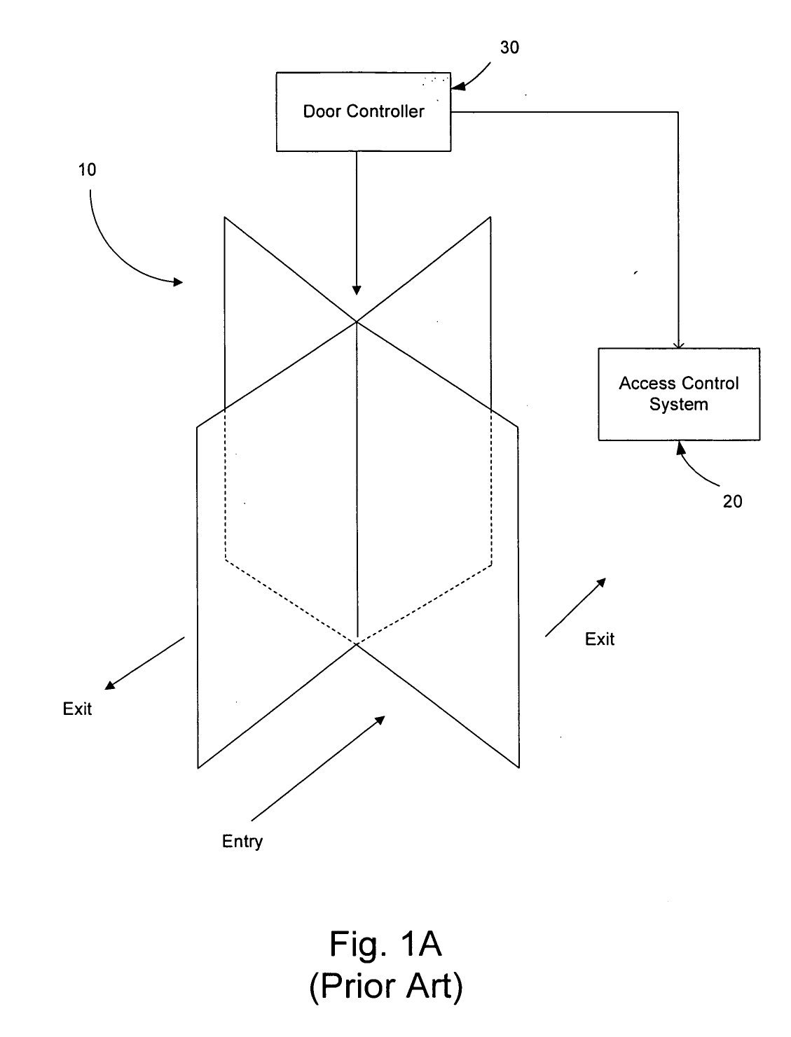

FIGS. 1B and 1C are top view diagrams of a revolving door for illustrating a non-people object being dragged through the portal;

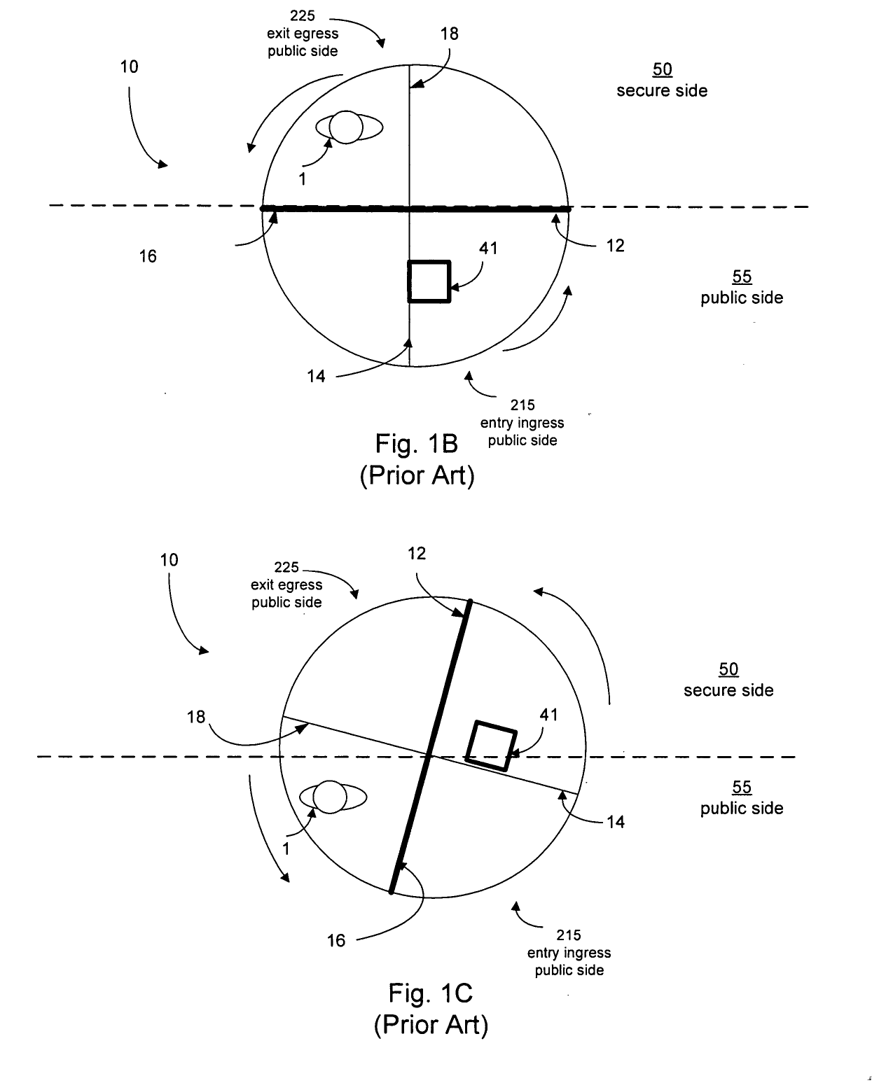

FIGS. 1D and 1E are top view diagrams of a revolving door for illustrating a non-people object attached to a wing of the revolving door;

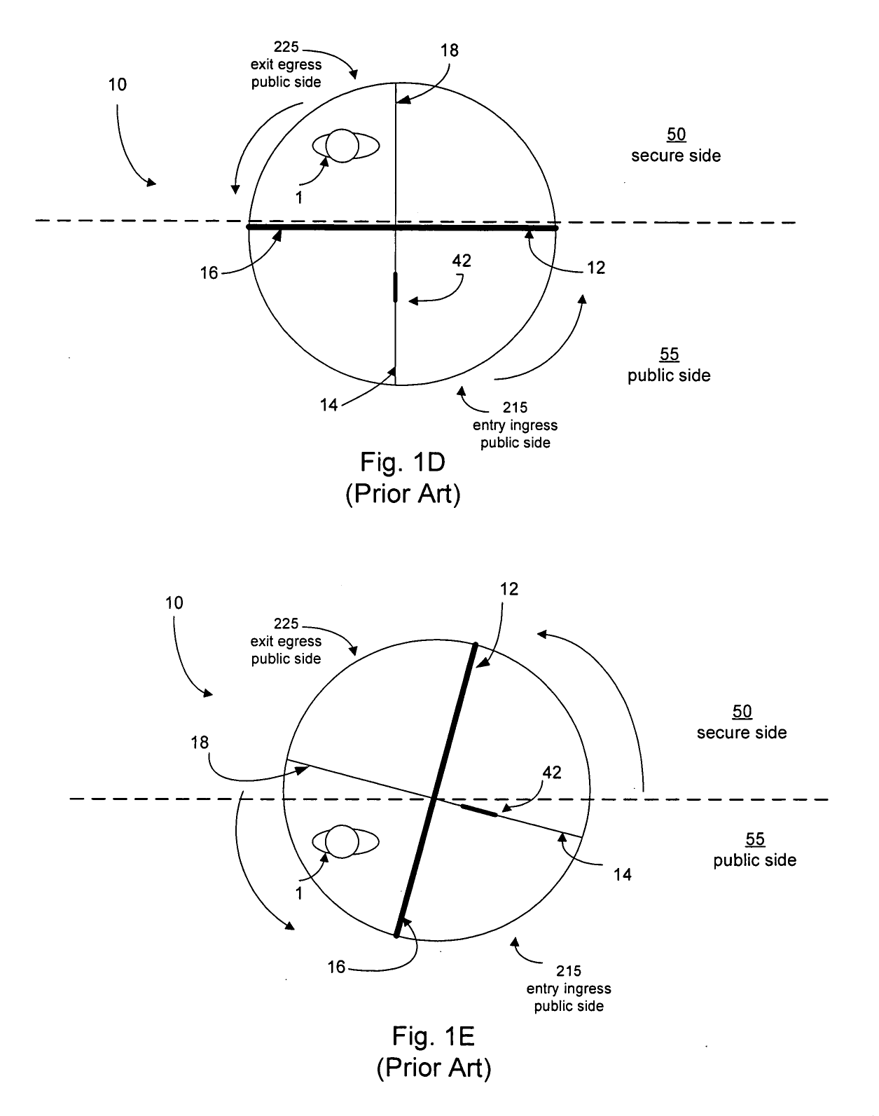

FIGS. 2A and 2B are top view diagrams of a revolving door illustrating a target volume being acquired according to one embodiment of the present invention;

FIG. 3 is a flow diagram illustrating a process for detecting non-people objects in a revolving door by creating a three-dimensional (3D) feature set of subtracted two-dimensional (2D) image sets according to the principles of the present invention;

FIG. 4 is a flow diagram illustrating an alternate process for detecting non-people objects in a revolving door through subtraction of 3D feature sets according to the principles of the present invention;

FIG. 5A is a perspective diagram of a revolving door showing ambiguity in object location;

FIGS. 5B and 5C are top view diagrams of a revolving door illustrating object locations having a perspective view as shown in FIG. SA; and

FIG. 6 is a schematic diagram illustrating the components of a stereo door sensor according to an embodiment of the present invention.

### DETAILED DESCRIPTION OF THE INVENTION

A description of preferred embodiments of the invention follows.

The present invention provides a method of detecting non-people objects within a revolving door chamber by first acquiring several two-dimensional (2D) images from different vantage points, and then computing a filtered set of 3D features of the door compartment by using both the acquired 2D images and model 2D images.

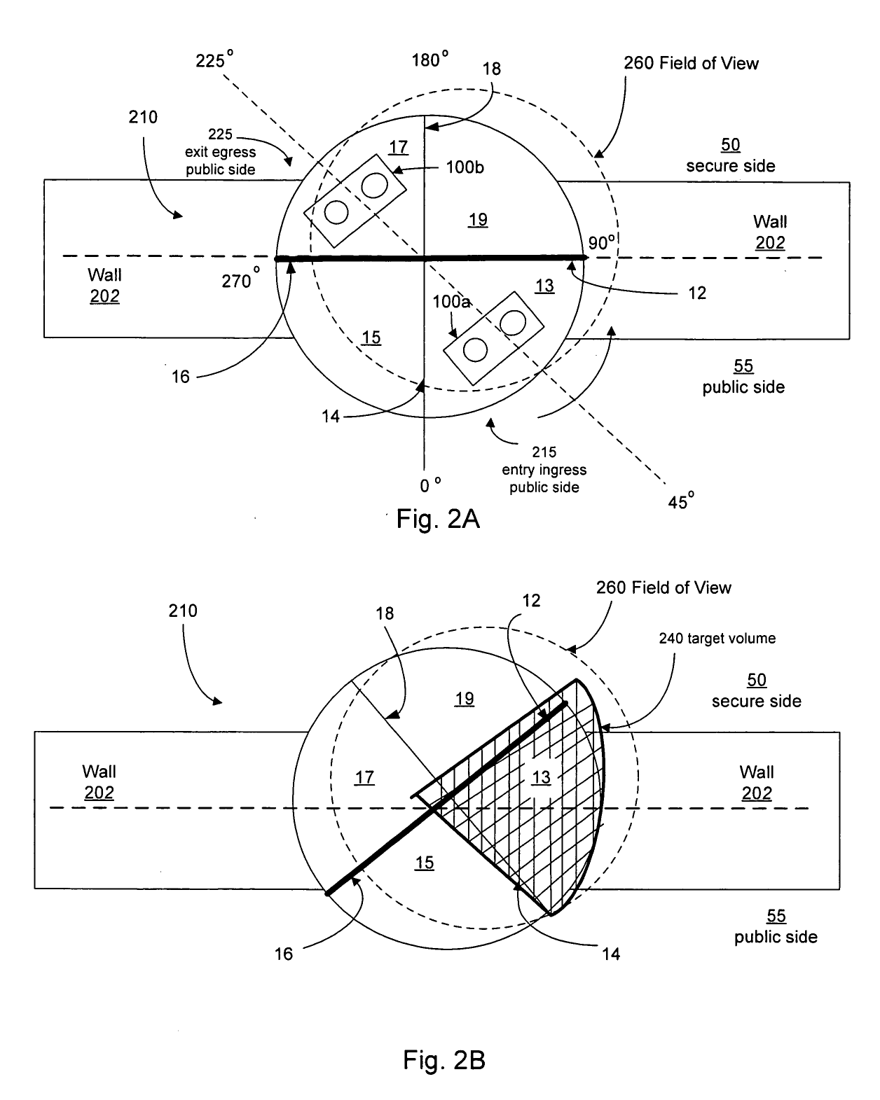

FIGS. 2A and 2B are top view diagrams of a revolving door illustrating a portal security system used to acquire a target volume in accordance with principles of the present invention. Referring to FIG. 2A, the entry leading quadrant 13 corresponds to the angles 0-90 degrees, the entry trailing quadrant 19 corresponds to 90-180 degrees, the exit leading quadrant 17 corresponds to 180-270 degrees and the exit trailing quadrant 15 corresponds to 270-360 degrees. The sensors 100a, 100b are spaced apart on opposite quadrants of the door 210 (i.e. the entry leading and exit leading quadrants). The sensors are preferably placed around the 45 degree and 225 degree diameter and oriented 90 degrees relative to the diameter. The stereo door sensors 100a, 100b can be positioned at standard ceiling heights of approximately 7 feet or more relative to the floor. The result of such positioning is that sensor 100a primarily monitors an ingress area also called the public side, while sensor 100b primarily monitors an egress area also called the secure side. The sensor preferably has a wide angular field of view in order to image tall people from 7 feet ceilings with minimal blind spots. Because the wings 12, 14, 16, 18 of the revolving door typically include transparent window portions, the field of view 260 extends through the door as it rotates. The field of view 260 corresponds to the field of view of the ingress area from sensor 100a. Sensor 100b obtains a similar field of view (not shown) of the egress area.

Referring to FIG. 2B, the door position is defined by wing 14 at 45 degrees. The sensor 100a (not shown) may have a 2D field of view 260 that encompasses a scene in which a substantial portion of the revolving door 210 is included. When the sensor 100a is initially installed, the target volume 240 is preferably configured to encompass a volume having an area corresponding to the interior of a door quadrant 13 that is defined by door wings 12, 14. Thus, in this example, the target volume 240 encompasses less than the full field of view 260. As shown in FIG. 2B, it may be desirable to include the door wings 12, 14 within the target volume 240 in order to detect objects attached to the door wings 12, 14 outside the door quadrant 13.

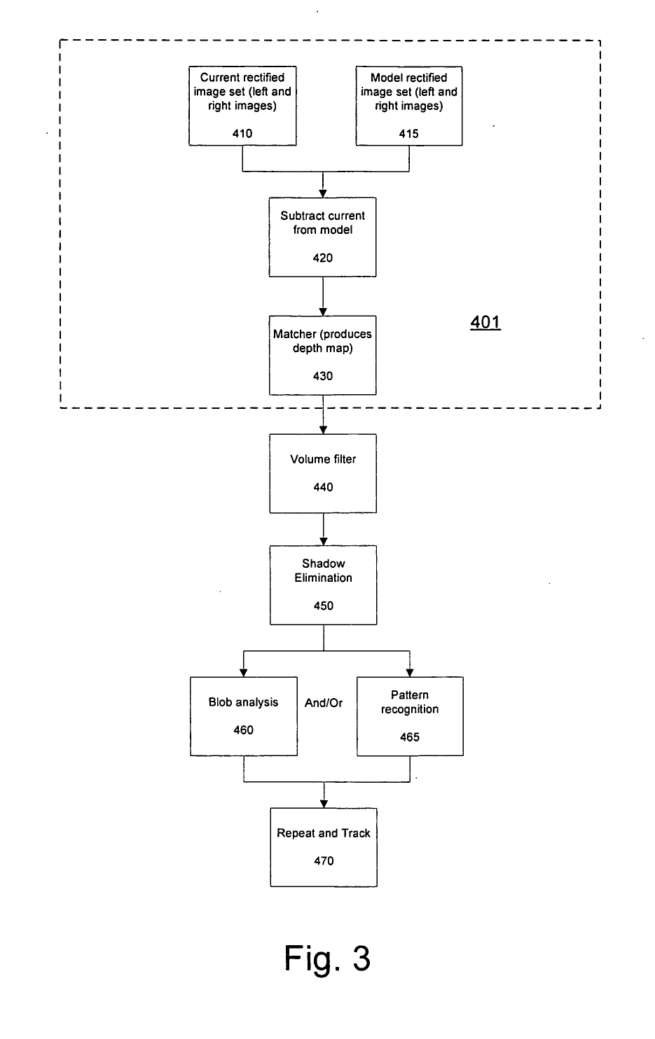

FIG. 3 is a flow diagram that illustrates one embodiment of a method for detecting non-people objects in a revolving door according to the principles of the present invention.

Upon a triggering event, a set of stereo cameras acquire 410 two-dimensional (2D) image sets covering a particular field of view for analysis. Preferably the images are rectified to obtain coplanar images for use in stereoscopic applications, as discussed in further detail below. A subtraction step 420 then compares the newly acquired images to a set of model 2D images of the same field of view 415. By subtracting the model rectified images and current rectified images from each other, the remaining image will be left with noise, shadows, and possibly foreign, non-people objects that first appear in the current image sets.

In an embodiment of the present invention, the model rectified images are averages of previously acquired images. In a preferred embodiment, these previously acquired images may be cleared images. Cleared images are acquired images where no objects have been detected. In particular, the model images may be calculated as a moving average where newly cleared images are weighed heavier than older cleared images. This scheme provides compensation for conditions that change in the field of view such as seasonal or daily lighting conditions, or new building features such as flagpoles or shrubbery. Each image incorporated into the average image will be taken at the same door position. In other embodiments, the model images may be derived from using various image processing filters to remove detected non-people objects from previously acquired images.

A constant triggering event helps provide consistency in the image acquisition, which in turn provides consistency in the creation of model images and ensures accuracy in the image subtraction. The triggering event may be, for example, the activation of a proximity sensor when a door wing realizes a certain position. Door positioning may be determined through physical means, through vision detection, or through some alternative sensing means. To provide more flexibility, there may be more than one defined position where images are acquired.

After the model image set and current image set are compared, the 2D images are processed in a matching step 430 to generate a “disparity map,” interchangeably referred to herein as a “depth map.” In this context, a “disparity” corresponds to a shift between a pixel in a reference image (e.g. an image taken from the left side) and a matched pixel in a second image (e.g. an image taken from the right side). The result is a disparity map (X_{R}, Y_{R}, D), where X_{R}, Y_{R} corresponds to the 2D coordinates of the reference image, and D corresponds to the computed disparities between the 2D images. The disparity map can provide an estimate of the height of an object from the ground plane because an object that is closer to the two cameras will have a greater shift in position between the 2D images. An example matching process is described in detail in U.S. patent application Ser. No. 10/388,925 titled “Stereo Door Sensor,” which is assigned to Cognex Corporation of Natick, Mass. and incorporated herein by reference.

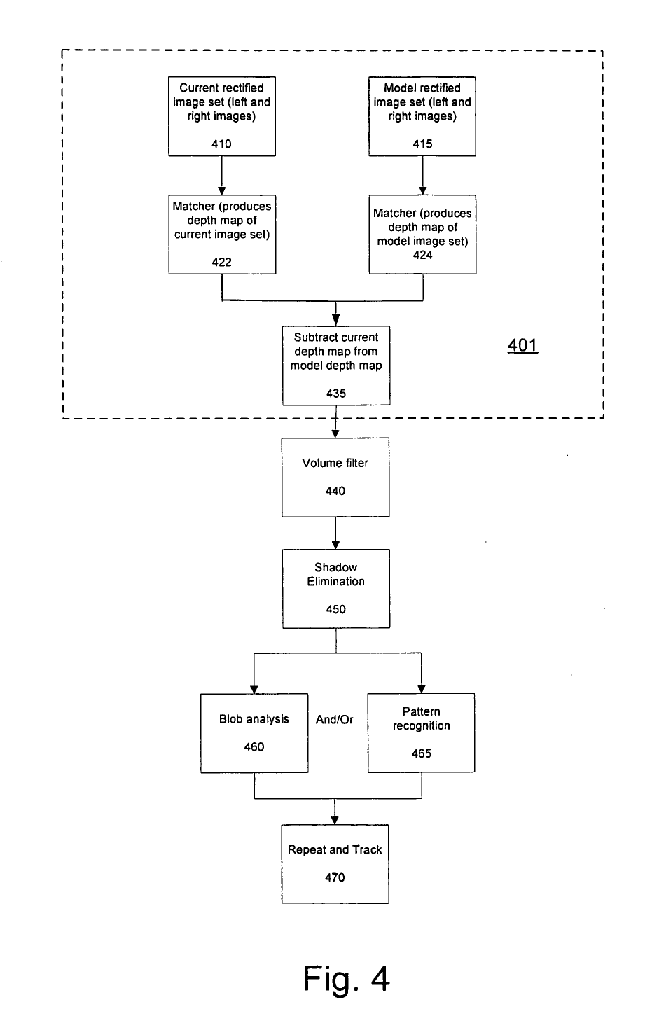

In an alternative embodiment, as shown in FIG. 4, a filtered disparity may be created by comparison of disparity maps. An acquired disparity map can be created directly from the acquired images 422. A model disparity map is created 424 using model images. The subtraction step 435 received the two disparity maps for comparison. In both FIG. 3 and FIG. 4, a general processing step 401 produces a filtered disparity map that removes the model image, and that resultant image is further processed in a volume filter step 440.

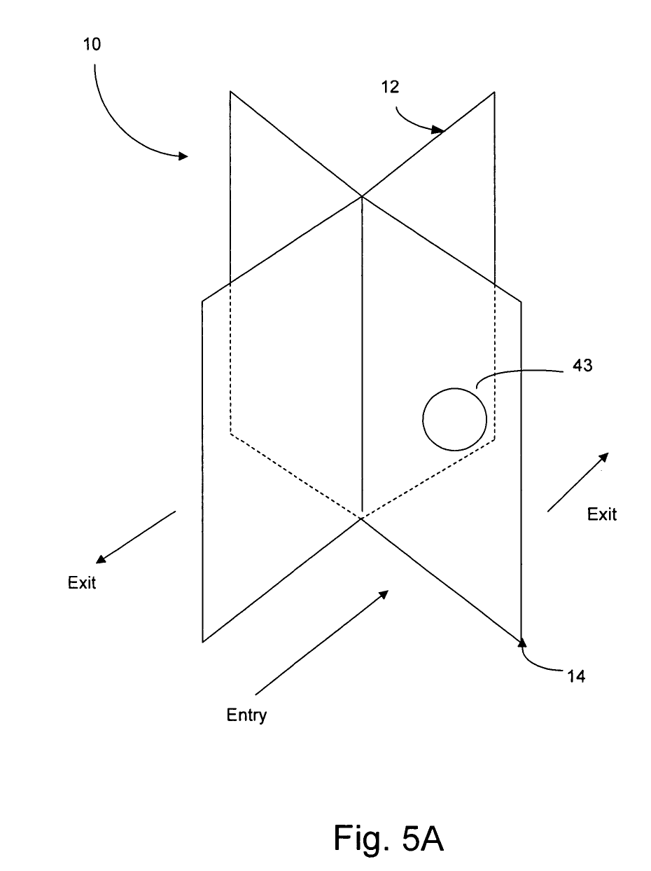

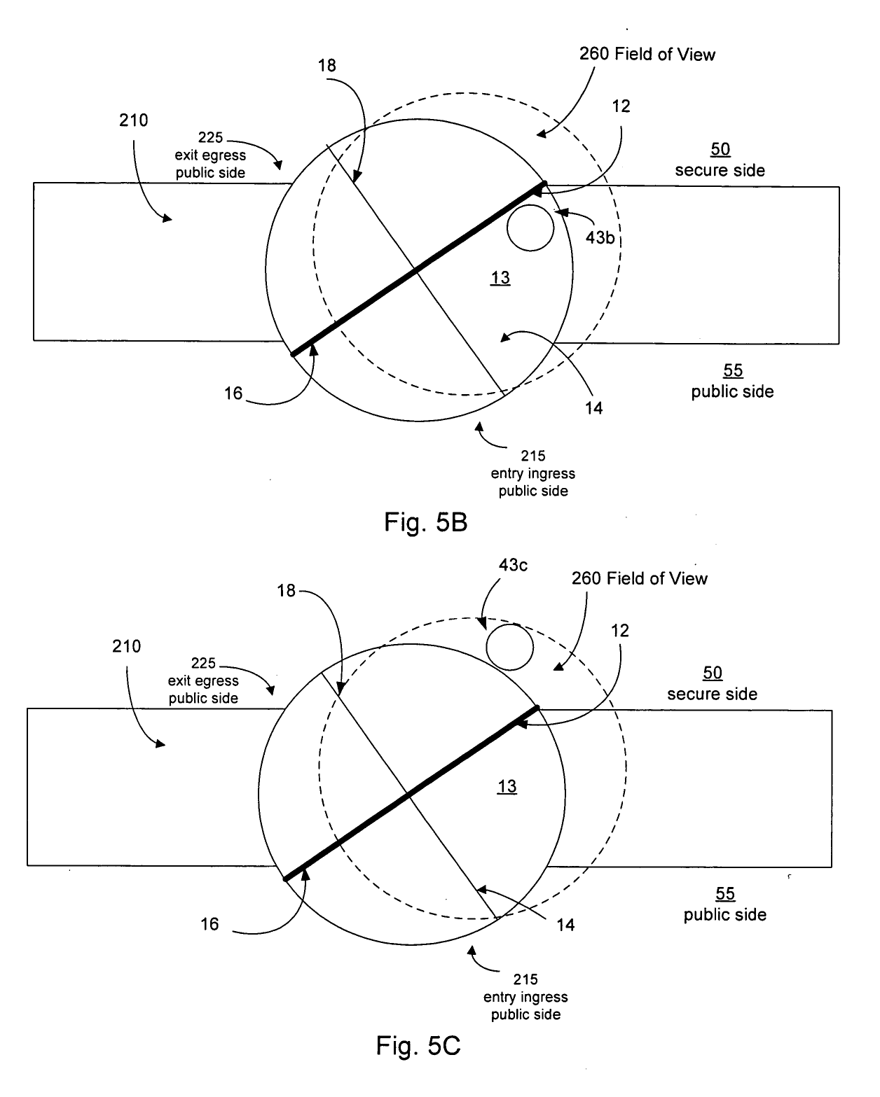

A target volume filter 440 receives the filtered disparity map, and removes the points located outside of the door chamber. As shown in FIG. 5A, transparent doors, such as glass, can create ambiguity as to the location of an object 43 in reference to the door 12. Since the disparity map can provide an estimate of height or depth within an image, the volume filter can distinguish between an object 43b located inside the quadrant 13 within the glass relative to the door 12 as shown by a top view in FIG. 5B, as opposed to an object 43c located outside the quadrant 13 relative to the door 12 as shown by a top view in FIG. 5C. Further, the size of the target volume may depend on the nature of the application. As shown in FIG. 2B, there may be areas located outside the immediate door wings 12, 14 where image analysis would be desired, for example, where there is concern that objects may be attached to the door wings. Once the volume filtering is complete, the remaining non-filtered points in the image can then be converted into a 2D image for image analysis.

Next, any one or more of several image processing filters, such as a shadow elimination filter 450, may be used on the filtered volume image to remove shadow or noise. Any one or more of several image processing filters may be run on the resulting filtered image set to remove shadows. In some embodiments of the present invention, a special floor can be used with special textures, patterns, or colors to help with shadow detection and elimination. For a discussion on various shadow detection techniques, refer to A. Prati, I. Mikic, M. M. Trivedi, R. Cucchiara, “Detecting Moving Shadows: Algorithms and Evaluation,” IEEE Transactions on Pattern Analysis and Machine Intelligence, Vol. 25, No. 7 (July 2003), pp. 918-923, the entire contents of which are incorporated herein by reference.

After the image processing has been completed to remove noise and shadow, the final image set may undergo object detection analysis, either in the form of blob analysis 460, pattern recognition 465, or a combination of the two. The blob analysis 460 may apply standard image segmentation or blob connectivity techniques to obtain distinct regions, i.e. collection of pixels, wherein each pixel represents a plurality of similar feature points. Based on its size or depth, a segmented blob may be identified as a suspect non-people object for detection. Thresholds for detection based on blob size or depth may vary dependent on the application of the present invention, and the types of non-people objects to be detected. For example, very large blobs may be ignored as people traveling through the revolving door, or very small blobs may be ignored to reduce sensitivity of the detection. Similarly, a pattern recognition analysis 465 may also apply standard image processing techniques to search the final image set for known non-people objects with distinctive shapes, such as knives or guns. Pattern recognition may be performed by Patmax® geometric pattern matching tool from Cognex Corporation, or by normalized correlation schemes to find specific shapes. Other object detection schemes know to those skilled in the arts may be used.

An embodiment of the present invention further may involve tracking an object for some number of image frames to confirm that the non-people object detector did not inadvertently detect a bizarre lighting event, such as a reflection of a camera flash, or some other random, instantaneous visual event. An example image tracking system is described in detail in U.S. patent application Ser. No. 10/749,335 titled “Method and Apparatus for Monitoring a Passageway Using 3D Images,” which is assigned to Cognex Corporation of Natick, Mass. and incorporated herein by reference.

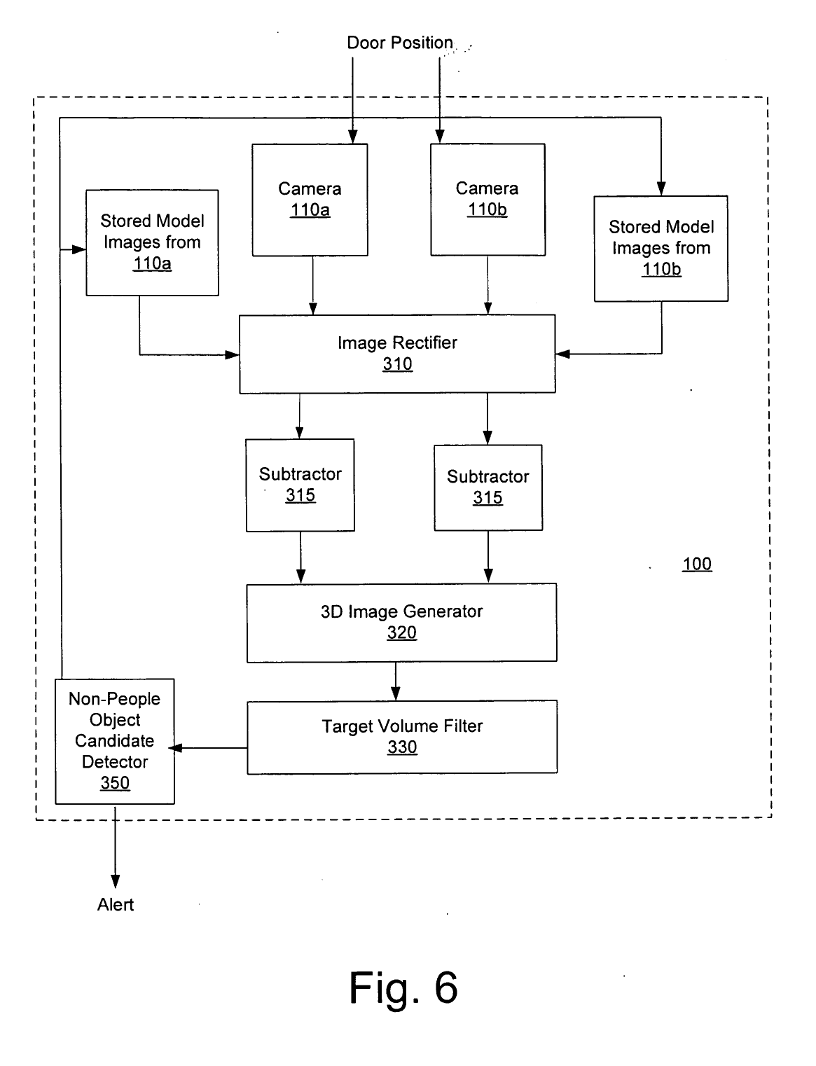

FIG. 6 is a schematic diagram illustrating the components of a stereo door sensor according to an embodiment of the present invention.

The sensor 100 includes at least two video cameras 110a, 110b that provide two-dimensional images of a scene. The cameras 110a, 110b are positioned such that their lenses are aimed in substantially the same direction. The cameras can receive information about the door position from proximity sensors or from a position encoder, in order to make sure there is consistency in the images for comparison.

In other embodiments, one or more cameras may be used to acquire the 2D images of a scene from which 3D information can be extracted. According to one embodiment, multiple video cameras operating in stereo may be used to acquire 2D image captures of the scene. In another embodiment, a single camera may be used, including stereo cameras and so-called “time of flight” sensor cameras that are able to automatically generate 3D models of a scene. In still another embodiment, a single moving camera may be used to acquire 2D images of a scene from which 3D information may be extracted. In still another embodiment, a single camera with optical elements, such as prisms and/or mirrors, may be used to generate multiple views for extraction of 3D information. Other types of cameras known to those skilled in the art may also be used.

The sensor 100 preferably includes an image rectifier 310. Ideally, the image planes of the cameras 110a, 110b are coplanar such that a common scene point can be located in a common row, or epipolar line, in both image planes. However, due to differences in camera alignment and lens distortion, the image planes are not ideally coplanar. The image rectifier 310 transforms captured images into rectified coplanar images in order to obtain virtually ideal image planes. The use of image rectification transforms are well-known in the art for coplanar alignment of camera images for stereoscopy applications. Calibration of the image rectification transform is preferably performed during assembly of the sensor.

For information on camera calibration, refer to R. Y. Tsai, “A Versatile Camera Calibration Technique for High-Accuracy 3D Machine Vision Metrology Using Off-the-Shelf TV Cameras and Lenses,” IEEE J. Robotics and Automation, Vol. 3, No. 4, pp. 323-344 (August 1987) (hereinafter the “Tsai publication”), the entire contents of which are incorporated herein by reference. Also, refer to Z. Zhang, “A Flexible New Technique for Camera Calibration,” Technical Report MSR-TR-98-71, MICROSOFT Research, MICROSOFT CORPORATION, pp 1-22 (Mar. 25, 1999) (hereinafter the “Zhang publication”), the entire contents of which are incorporated herein by reference.

Subtractors 315 receive the rectified images, along with a pair of model images, and process them to remove background images. Ideally, a subtractor leaves only items that do not appear in the model images, although noise and error can sometimes leave image artifacts.

A 3D image generator 320 generates 3D models of scenes surrounding a door from pairs of the filtered rectified images. This module performs the matcher step 430 shown in FIG. 3. In particular, the 3D image generator 320 can generate a 3D model, or feature set, in 3D world coordinates such that the model accurately represents the image points in a real 3D space.

A target volume filter 330 receives a 3D feature set of a door scene and clips all 3D image points outside the target volume. This module performs the volume filter step 440 shown in FIG. 3. The target volume is a static volume set in reference to a door position, or angle. Any image points within the 3D model that fall within the target volume are forwarded to a non-people object candidate detector 350.

In an another embodiment, the filter 330 may receive the rectified 2D images of the field of view, clip the images so as to limit the field of view, and then forward the clipped images to the 3D image generator 320 to generate a 3D model that corresponds directly to a target volume.

The non-people object candidate detector 350 can perform multi-resolution 3D processing such that each 3D image point within the target volume is initially processed at low resolution to determine a potential set of people candidates. From that set of non-people object candidates, further processing of the corresponding 3D image points are performed at higher resolution to confirm the initial set of non-people candidates within the target volume. Some of the candidates identified during low resolution processing may be discarded during high resolution processing. As discussed earlier, various image processing and image analysis techniques can be applied to locate non-people objects within the target volume, and various detection thresholds may be adjusted based on the nature of the application.

The non-people object candidate detector 350 can provide an alert to either a human operator, or an automated system. By providing an alert before the revolving door rotates into a position where door wing 12 opens the compartment up to the secured areas, a door controller may employ preventative action before a non-people object can be accessed. If the non-people object candidate detector 350 clears the target volume, the respective camera images can be stored and processed into model images.

It will be apparent to those of ordinary skill in the art that methods involved in the present invention may be embodied in a computer program product that includes a computer usable medium. For example, such a computer usable medium may consist of a read only memory device, such as a CD ROM disk or conventional ROM devices, or a random access memory, such as a hard drive device or a computer diskette, having a computer readable program code stored thereon.

Although the invention has been shown and described with respect to exemplary embodiments thereof, persons having ordinary skill in the art should appreciate that various other changes, omissions and additions in the form and detail thereof may be made therein without departing from the spirit and scope of the invention.

What is claimed is:

1. A method of detecting objects comprising:
acquiring a plurality of 2D images of a space in a revolving door;
computing a filtered set of 3D features using the plurality of acquired 2D images and a plurality of model 2D images; and
identifying non-people objects within the revolving door space.

2. A method of claim 1 wherein the filtered set of 3D features is a disparity map.

3. A method of claim 1 wherein computing a filtered set of 3D features comprises:
computing a set of acquired 3D features from the plurality of acquired 2D images;
computing a set of model 3D features from the plurality of model 2D images; and
filtering the set of model 3D features from the set of acquired 3D features.

4. A method of claim 1 wherein computing a filtered set of 3D features comprises:
filtering the plurality of model 2D images from the plurality of acquired 2D images to create a plurality of filtered 2D images; and
computing the filtered set of 3D features from the plurality of filtered 2D images.

5. A method of claim 4 further comprising:
processing the filtered set of 3D features to minimize shadow and noise.

6. A method of claim 4 wherein identifying non-people objects comprises a blob analysis.

7. A method of claim 4 wherein identifying non-people objects comprises pattern recognition.

8. A method of claim 1 further comprising:
eliminating transient non-people objects from detection by tracking identified non-people objects.

9. A method of claim 1 wherein acquiring a plurality of 2D images occurs in response to a triggering event.

10. A method of claim 9 wherein the triggering event is the detection of a particular door position.

11. A method of claim 1 wherein the model images are an average of previously acquired images taken over a period of time.

12. A method of claim 1 wherein the model images are an average of filtered previously acquired images taken over a period of time.

13. A method of claim 1 wherein the model images are an average of cleared images taken over a period of time.

14. A method of claim 13 wherein recently cleared images are weighed more heavily.

15. A method of claim 1 further comprising transmitting an alert in response to the identification of a non-people object.

16. A method of claim 1 further comprising stopping the revolving door in response to the identification of a non-people object.

17. A secured portal comprising:
a revolving door separating a first area from a second area;
a plurality of image sensors positioned to acquire a plurality of 2D images in a space in the revolving door; and
a processor for detecting non-people objects by:
(i) computing a filtered set of 3D features using the plurality of acquired 2D images and a plurality of model 2D images, and
(ii) identifying non-people objects in the revolving door space using the filtered set of 3D features.

18. A secured portal of claim 17 wherein the filtered set of 3D features is a disparity map.

19. A secured portal of claim 17 wherein computing a filtered set of 3D features comprises:
computing a set of acquired 3D features from the plurality of acquired 2D images;
computing a set of model 3D features from the plurality of model 2D images; and
filtering the set of model 3D features from the set of acquired 3D features.

20. A secured portal of claim 17 wherein computing a filtered set of 3D features comprises:
filtering the plurality of model 2D images from the plurality of acquired 2D images to create a plurality of filtered 2D images; and
computing the filtered set of 3D features from the plurality of filtered 2D images.

21. A secured portal of claim 20 further comprising:
processing the filtered set of 3D features to minimize shadow and noise.

22. A secured portal of claim 17 wherein identifying non-people objects comprises a blob analysis.

23. A secured portal of claim 17 wherein identifying non-people objects comprises pattern recognition.

24. A secured portal of claim 17 wherein the processor further eliminates transient non-people objects from detection by tracking identified non-people objects.

25. A secured portal of claim 17 wherein the plurality of image sensors acquire the plurality of 2D images in response to a triggering event.

26. A secured portal of claim 25 wherein the triggering event is the detection of a particular door position.

27. A secured portal of claim 17 wherein the model images are an average of previously acquired images taken over a period of time.

28. A secured portal of claim 17 wherein the model images are an average of filtered previously acquired images taken over a period of time.

29. A secured portal of claim 17 wherein the model 2D images are an average of cleared images taken over a period of time.

30. A secured portal of claim 29 wherein recently cleared images are weighed more heavily.

31. A secured portal of claim 17 wherein the processor is further capable of transmitting an alert in response to the identification of a non-people object.

32. A secured portal of claim 31 further comprising:
a control system for stopping movement of the revolving door upon receipt of an alert.

33. A computer readable medium having computer readable program codes embodied therein for causing a computer to function as an analysis unit that selectively designates prohibited communications connections between an origin and one or more destinations in a communications network, the computer readable medium program codes performing functions comprising:
acquiring a plurality of 2D images of a space in a revolving door;
computing a filtered set of 3D features using the plurality of acquired 2D images and a plurality of model 2D images; and
identifying non-people objects within the revolving door space.

34. A security method comprising:
acquiring a plurality of 2D images of a space in a revolving door;
identifying a non-people object within the revolving door space; and
transmitting an alert upon detection of the non-people object.

35. A method of claim 34 further comprising:
stopping the revolving door in response to the alert.
